(19) United States
(12) Patent Application Publication
(10) Pub. No.: US 2011/0138200 A1
(43) Pub. Date: Jun. 9, 2011

(54) TERMINAL DEVICE AND POWER SAVING CONTROL METHOD

(76) Inventor: Michio Tomizawa, Tokyo (JP)

(21) Appl. No.: 12/737,389

(22) PCT Filed: Jul. 8, 2008
(86) PCT No.: PCT/JP2008/062309

§ 371 Date: Jan. 7, 2011

(51) Int. Cl. G06F 1/26; G06F 1/32

(52) U.S. Cl. 713/310

(57) ABSTRACT

A terminal device that can be remotely controlled in a time range that is freely set up even in a power saving mode is provided. The terminal device includes input section 2; communication means that can communicate with an external device; power supply control section 5 that supplies power to the communication means; calendar IC 6 into which is set an interrupt start time and an end time and which generates an interrupt start command at the start time and an interrupt end command at the end time; backup power supply 7 that supplies power to calendar IC 6; and CPU 1 that controls power control section 5 to perform a power supply operation. CPU 1 causes power control section 5 to supply power to the communication means in a time range decided by the interrupt start command and the interrupt end command that CPU 1 has generated so as to allow input section 2 and the communication section to be used.

### TECHNICAL FIELD

The present invention relates to a terminal device typified by a projector, in particular, a terminal device having a function that reduces power consumed in a standby state (power saving mode).

### BACKGROUND ART

In recent years, as projectors have been provided with multi-functions, power that is consumed in a standby state (standby power) has increased. Thus, recent projectors are provided with a power saving mode in which their standby power is reduced.

A projector having the power saving mode is disclosed in Patent Document 1 (JP2004-21218A). This projector has timing means that times an elapsed time period of a state in which an image signal is not supplied from an external device (no signal state) and an elapsed time period of a state in which an input operation is not performed for the projector (no operation state); power saving mode switching means that switches the operation mode of the projector from a regular mode to a power saving mode if the elapsed time period of the no signal state or no operation state exceeds a predetermined time period; and power saving mode changing announcement means that announces changing to the power saving mode before switching to the power saving mode.

The power saving mode switching means executes switching to the power saving mode if the no signal state or the no operation state has been maintained further for a predetermined time period after the announcement of changing to the power saving mode. The timing means, the power saving mode switching means, and the power saving mode changing announcement means are a part of a control section composed of a CPU (Central Processing Unit).

Regularly, in the power saving mode, only minimal essential functions are operated and power is not supplied to a light source and sections, a communication section that communicates with an external device, or the like. The minimal essential functions, specifically, are functions of the CPU that receives a command signal from a remote controller (hereinafter referred to as a remocon) or a main body operation section of the projector and that cancels the power saving mode. Thus, in the power saving mode, most functions including the communication function enter a stop state, for example, the projector that has changed to the power saving mode is incapable of being remotely controlled by the external device through a network. Thus, the way in which the power save mode is used may create a sense of inconvenience because the remote control cannot be used in the power saving.

Next, a example of use of the power save mode which creates a sense of inconvenience will be exemplified.

As light sources for projectors, a metal halide lamp, an extra high pressure mercury lamp, and so forth are known; these types of lamps require, to some extent, a certain period of time until their output level becomes stable after power is supplied to them.

In the case in which a projector is used for a conference or the like, by starting supplying power to the light source of the projector by a remote control before the conference commences, the projector can stably project images immediately after the conference commences. By contrast, if the power saving mode has been set up for the projector before the conference commences, the projector is incapable of being remotely controlled.

If the projector is maintained in the regular mode in which power is always supplied to each section of the projector to allow it to be remotely controlled, power is wastefully consumed.

As is clear from the above description, when the operation mode of the projector is set in the power saving mode, since the projector cannot be remotely controlled, this inability to remotely control the projector before the start of a conference is an inconvenient.

The projector described in Patent Document 1 also has a problem of the above-mentioned inconvenience.

In addition, terminal devices other than projectors, for example, those that necessitate a constant time period until their operation becomes stable, after power is supplied, also have a problem of inconvenience in which they are incapable of being remotely controlled in the power saving mode.

Moreover, up to the present, a technique that enables a terminal device to operate in a power saving mode so as to conserve power and that allows the terminal device, that has been switched to the power saving mode, to be remotely controlled so as to enhance convenience has not been provided.

### DISCLOSURE OF THE INVENTION

An object of the present invention is to solve the above-described problems and provide a terminal device and a power saving control method that allows use of the remote control within any time range that has been freely decided upon in any manner even when the power saving mode has been engaged.

To accomplish the above-described object, the terminal device of the present invention is a terminal device, comprising:

an input section;

communication means that communicates with an external device;

a power supply control section that supplies power to said communication means;

a calendar function section into which is set an interrupt start time and an end time and which generates an interrupt start command at the start time and an interrupt end command at the end time;

a backup power supply that always supplies power to said calendar function section; and

a control section that controls said power supply control section to perform a power supply operation,

wherein said control section causes said power supply control section to supply power to said communication means in a time range which is decided by the interrupt start command and the interrupt end command which were generated by said calendar function section so as to allow said input section and communication section to be used.

A power saving control method of the present invention is the power saving control method, comprising:

causing a backup power supply to operate a calendar function section into which is set an interrupt start time and an end time and which generates an interrupt start command at the start time and an interrupt end command at the end time; and

supplying power to communication means that communicates with an external device in a time range decided by the interrupt start command and the interrupt end command that said calendar function section has generated.

### BRIEF DESCRIPTION OF DRAWINGS

FIG. 1 is a block diagram showing the structure of a terminal device that is an exemplary embodiment of the present invention;

FIG. 2 is a schematic diagram showing a function stop state in a power saving mode of the terminal device shown in FIG. 1;

FIG. 3 is a flowchart showing a procedure of an operation mode switching process in the power saving mode, the process being performed in the terminal device shown in FIG. 1; and

FIG. 4 is a block diagram showing principal sections of a projector to which the present invention is applied.

### DESCRIPTION OF REFERENCE NUMERALS

1 CPU
2 Input section
3 Communication control section
4 Interface section
5 Power supply control section
6 Calendar IC
6a Time setup value storage section
6b Counter
7 Backup power supply
8

### BEST MODES FOR CARRYING OUT THE INVENTION

Next, an exemplary embodiment of the present invention will be described with reference to drawings.

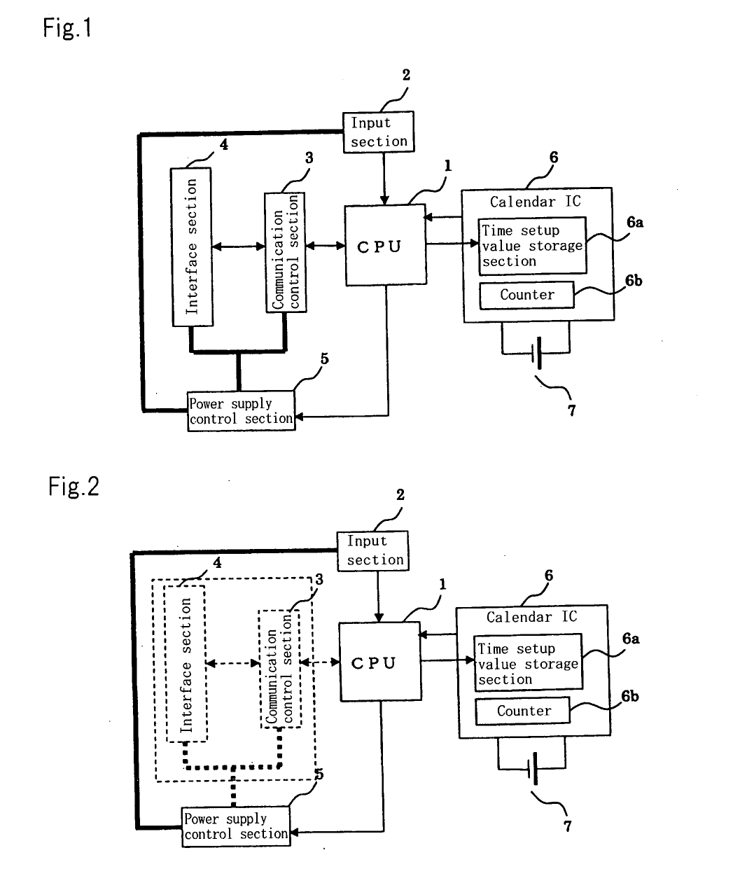

FIG. 1 is a block diagram showing the structure of a terminal device that is an exemplary embodiment of the present invention. The terminal device shown in FIG. 1 is a terminal device typified by a projector, principal sections of which are CPU 1, input section 2, communication control section 3, interface section 4, power supply control section 5, calendar IC 6, and backup power supply 7.

Input section 2 includes a main body operation section disposed on the main body of the terminal device and a remocon. The main body operation section and the remocon each has a plurality of buttons and the user can control the operation of the terminal device by performing an input operation using these buttons.

Interface section 4 is a hardware interface that serves to connect an external device such as a personal computer (PC) to the terminal device. Interface section 4 includes an interface serving to be connected to an LAN, an RS-232C interface, and so forth. Interface section 4 is connected to CPU 1 through communication control section 3.

Communication control section 3 controls communications between interface section 4 and CPU 1. Power supply control section 5 is connected to a main power supply circuit and supplies power to the main body operation section, which is input section 2, interface section 4, communication control section 3, and other sections (a light source, a liquid crystal panel, and so forth) that compose the terminal device.

Calendar IC 6 has time setup value storage section 6a and counter 6b. Counter 6b is a clock function section that manages the current time (or current date and time). Calendar IC 6 obtains the current time based on an output of counter 6b.

Time setup value storage section 6a serves to store an interrupt start time and an interrupt end time in the power saving mode. The interrupt start time and the interrupt end time can be freely set up by the user through input section 2. When the current time becomes the interrupt start time stored in time setup value storage section 6a, calendar IC 6 outputs a regular standby start command to CPU 1. When the current time becomes the interrupt end time stored in time setup value storage section 6a, calendar IC 6 outputs a regular standby end command to CPU 1.

Backup power supply 7 supplies power to calendar IC 6. Calendar IC 6 can always operate with power supplied by backup power supply 7 regardless of the operation mode of the terminal device.

CPU 1 controls the operation of each section of the terminal device, accepts an input command from the user through input section 2, and executes a necessary process or control based on the command. Specifically, CPU 1 performs an operation mode switching process, a mode interrupt process, a start time setup process for the interrupt process, and so forth. The processes or controls by CPU 1 are basically accomplished by causing CPU 1 to operate according to a program.

The operation modes include, for example, three modes of the regular mode, the power saving mode, and the regular standby mode. In the regular mode, power supply control section 5 supplies power to each section (including the main body operation section, which is input section 2, communication control section 3, and interface section 4) based on a control signal supplied from CPU 1. In the power saving mode, power supply control section 5 supplies power only to the main body operation section based on a control signal supplied from CPU 1. In the regular standby mode, power supply control section 5 supplies power to the main body operation section and interface section 4 based on a control signal supplied from CPU 1.

Power is supplied directly from the main power supply circuit to CPU 1. In the power saving mode and the regular standby mode, power that maintains minimal essential functions (standby power) is supplied from the main power supply circuit to CPU 1. The minimal essential functions include a first function serving to return from the power saving mode or the regular standby mode to the regular mode and a second function serving to perform an interrupt process in the power saving mode. In the first function, CPU 1 receives a command signal (cancellation command) from the remocon or the main body operation section and cancels the power saving mode or the regular standby mode that has been currently set up. In the second function, CPU 1 receives a regular standby start command from calendar IC 6 to execute a changing process from the power saving mode to the regular standby mode, and then CPU 1 receives a regular standby end command from calendar IC 6 to maintain the state that has been set up in the regular standby mode.

In addition, CPU 1 measures an elapsed time period of a state in which an image signal is not supplied from the external device connected to interface section 4 (no signal state) and an elapsed time period of a state in which a signal is not received from input section 2 (no operation state) in the regular mode and if the elapsed time period of the no signal state or no operation state exceeds a threshold, CPU 1 switches the operation mode of the terminal device from the regular mode to the power saving mode. As means to switch from the regular mode to the power saving mode, for example, a technique described in Patent Document 1 may be applied.

Next, the operation of the terminal device of this embodiment will be specifically described.

(1) Setting up the start time and end time of the interrupt process in the power saving mode:

The user sets up the start time and the end time of the interrupt process in the power saving mode through input section 2. When an input operation that specifies the start time is performed on input section 2, CPU 1 stores the specified start time to time setup value storage section 6a of calendar IC 6. Thereafter, when an input operation that specifies the end time is performed on input section 2, CPU 1 stores the specified end time to time setup value storage section 6a of calendar IC 6. Alternatively, the start time and the end time may be set up by a remote control of the external device.

(2) Switching process of operation mode:

When the power supply of the terminal device is turned on, CPU 1 controls the operation of each section in the regular mode. Thereafter, CPU 1 measures the elapsed time period of the no signal state or the no operation state and if the timed value exceeds a threshold, CPU 1 switches the operation mode of the terminal device from the regular mode to the power saving mode.

FIG. 2 is a schematic diagram showing the function stop state of the terminal device for which the power saving mode has been set up. In FIG. 2, functions that have been stopped are represented by dotted lines. In the power saving mode, power has been supplied to CPU 1, input section 2, and calendar IC 6, whereas power has not been supplied to other sections including communication control section 3 and interface section 4. Thus, the terminal device is incapable of being remotely controlled by the external device.

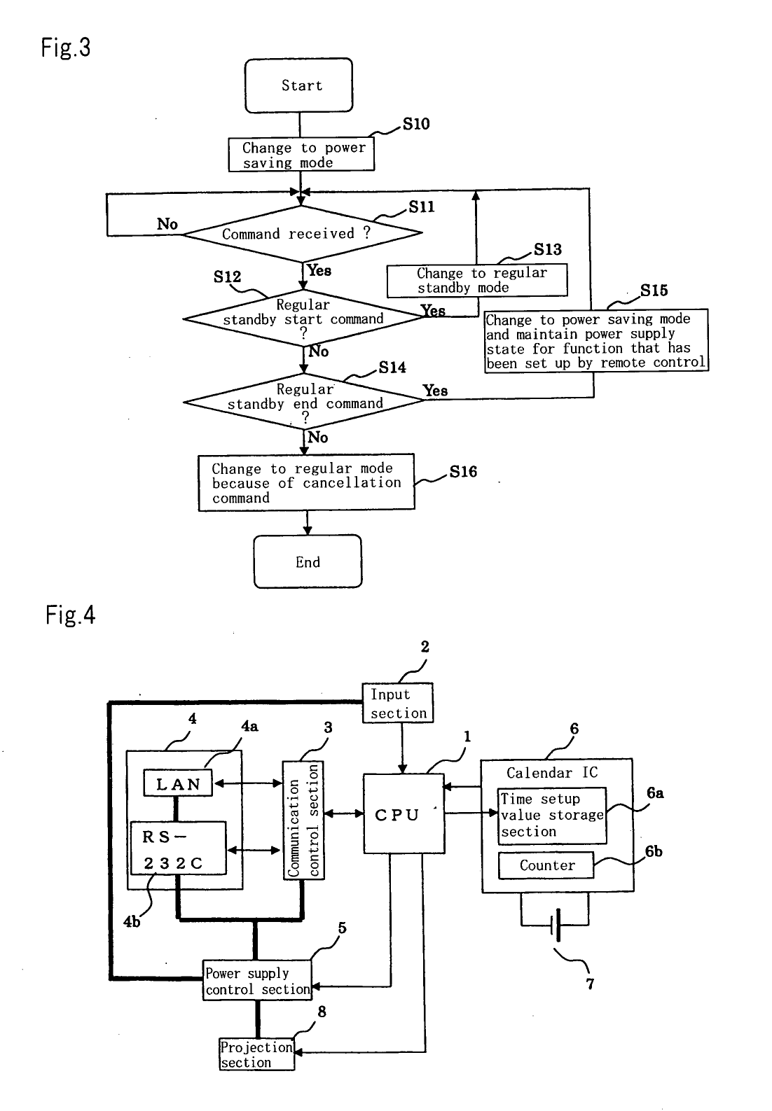

In the terminal device in which the power saving mode has been set up, the operation mode switching process is executed by CPU 1. FIG. 3 shows a procedure of the operation mode switching process in the power saving mode.

When changed to the power saving mode (at step S10), CPU 1 determines whether or not it has received a command signal from input section 2 or calendar IC 6 (at step S11). In the case that CPU 1 has received a command signal, it determines whether the received command signal is the regular standby start command, the regular standby end command, or the cancellation command (at steps S12, S14).

In the case that the received command signal is the regular standby start command (“Yes” at step S12), CPU 1 switches the operation mode of the terminal device from the power saving mode to the regular standby mode (at step S13). Power supply control section 5 supplies power to communication control section 3 and interface section 4 based on a control signal supplied from CPU 1. Thus, the terminal device can be remotely controlled by the external device. By remotely controlling the terminal device on the external device, the user can operate at least one of the functions that have been stopped. For example, CPU 1 causes a list of functions that have been stopped to appear on the external device and supplies to power supply control section 5 a command that causes power supply control section 5 to supply power to the function that the user has selected. Power supply control section 5 supplies power to the function that CPU 1 has instructed. The list of functions may have a regular mode item as a selection item. In this case, when the regular mode is selected, power supply control section 5 starts supplying power to each section.

In the case that the received command signal is the regular standby end command (“Yes” at step S14), CPU 1 switches the regular standby mode to the power saving mode (at step S15). However, in this mode switching, power supply control section 5 stops supplying power to communication control section 3 and interface section 4 based on a control signal supplied from CPU 1 and maintains the power supply state for the function that has been set up by remote control in the regular standby mode. Since power supplied to communication control section 3 and interface section 4 is stopped, a remote control for the terminal device by the external device is incapable of being executed again. In the case that the regular mode has been selected by a remote control, the regular standby mode changes to the regular mode.

In the case that the received command signal is the cancellation command (“No” at step S14), CPU 1 switches the operation mode of the terminal device from the power saving mode to the regular mode. Thereafter, power supply control section 5 starts supplying power to each of the sections including communication control section 3 and interface section 4 based on a control signal supplied from CPU 1. Thus, all the functions of the terminal device operate.

According to the terminal device of this embodiment that has been described above, even if the power saving mode has been set up, in the time range of the interrupt start time and the interrupt end time that the user has set up in advance, the mode changes from the power saving mode to the regular standby mode, so that the terminal device can be remotely controlled by the external device. Thus, by setting up the power saving mode for the operation mode of the terminal device, while power saving is accomplished, the terminal device that has changed to the power saving mode can be remotely controlled by the external device through a network so as to improve convenience.

The terminal device of this embodiment can be applied to a projector. FIG. 4 is a block diagram showing principal sections of the projector to which the present invention is applied.

The projector shown in FIG. 4 has projection section 8 in addition to the structure shown in FIG. 1. Interface 2 includes LAN interface section 4a and RS-232C interface section 4b.

Projection section 8 has a light source, an image signal processing circuit, a spatial light modulator, and a projection optical system. Power supply control section 5 supplies power to the light source, the image signal processing circuit, the spatial light modulator, and the projection optical system based on a control signal supplied from CPU 1. The spatial light modulator is composed of a liquid crystal panel, a DMD (Digital Micromirror Device), and so forth.

An image signal is supplied from the external device to the image signal processing circuit through LAN interface section 4a or RS-232C interface section 4b, communication control section 3, and CPU 1. The image signal processing circuit performs a process necessary for the spatial light modulator to generate image light based on the image signal supplied from the external device. The spatial light modulator generates image light based on the image signal supplied from the image signal processing circuit. The image light generated by the spatial light modulator is projected on a screen by the projection optical system.

Hereinafter, assuming that the projector has been installed in a conference room, the case in which the light source of the projector is operated by remote control before the conference commences will be described.

The user sets up the start time and the end time of the interrupt process in the power saving mode for the projector installed in the conference room through input section 2. In the case in which the conference commences at 10 o'clock in the morning, the user sets the start time and the end time of the interrupt process, for example, to 50 minutes past 9 o'clock in the morning and 10 o'clock in the morning, respectively. In the following description, it is assumed that the operation mode of the projector changes to the power saving mode before 50 minutes past 9 o'clock in the morning.

When the current time becomes 50 minutes past 9 o'clock in the morning, calendar IC 6 transmits the regular standby start command to CPU 1. When CPU 1 receives the regular standby start command from calendar IC 6, CPU 1 commands power supply control section 5 to supply power to LAN interface section 4a (changes to the regular standby mode). Power supply control section 5 supplies power to LAN interface section 4a as commanded by CPU 1. Thus, the projector enters the regular standby mode, allowing the projector to communicate with the external device through the LAN.

After the operation mode of the projector changes to the regular standby mode, the user connects his or her PC to the LAN and executes access to the projector. In this case, it is assumed that the address of the projector on the LAN has been assigned. In addition, the PC has a table on which individual functions of LAN interface section 4a, RS-232C interface section 4b, the light source, the image signal processing circuit, the spatial light modulator, the projection optical system, and so forth have been correlated with their identification information and with reference to this table, the PC causes power supply control section 5 to selectively supply power to each of the functions.

When the PC and the projector achieve a communicable state with each other, CPU 1 causes a list of functions (the light source, the image signal processing circuit, the spatial light modulator, the projection optical system, and so forth) that have been stopped to appear on the PC. The user selects a function for which power is to be supplied from those on the list that appear on the PC. In this case, it is assumed that the light source is selected as a function for which power is to be supplied.

The PC supplies to CPU 1 a signal that denotes that the light source has been selected. CPU 1 receives the signal and causes power supply control section 5 to supply power to the light source.

When the current time becomes 10 o'clock in the morning, calendar IC 6 transmits the regular standby end command to CPU 1. When CPU 1 receives the regular standby end command from calendar IC 6, CPU 1 commands power supply control section 5 to stop supplying power to LAN interface section 4a and to maintain the power supply state for the function (light source) designated by a remote control. Power supply control section 5 stops supplying power to LAN interface section 4a as commanded by CPU 1, but maintains power supplied to the light source.

With the above-described operation, the user can cause power to be supplied to the light source of the projector by a remote control on his or her PC. Thus, when the conference commences, since the light source of the projector is in its operation state, projected images can be stably obtained from the projector immediately after the conference commences.

Although the main body operation section, the remocon reception circuit, and CPU 1 consume power in the power saving mode, the amount consumed power is small. By contrast, in the regular standby mode, LAN interface section 4a and RS-232C interface section 4b also consume power as well as the main body operation section, the remocon reception circuit, and CPU 1. Since the amount of power consumed in these LAN interface section 4a and RS-232C interface section 4b is greater than that in the main body operation section, the remocon reception circuit, and CPU 1, it is not desirable that the regular standby mode be maintained for a long time period from a viewpoint of power saving. According to the projector of this embodiment, by contrast, the power saving mode is set up in the time range during which the conference is not held and the projector changes to the regular standby mode only in the time range that the user has set up in advance before the conference commences. Thus, if the time range that the user sets up in advance is a short time range, for example, around 10 minutes, measures can be taken for power saving. For example, in the case in which control is made such that the regular standby mode is set up, for example, for 10 minutes of the 1 hour (the power consumption is 10 W) and the power saving mode is set up, for example, for the remaining 50 minutes (the power consumption is 0.1 W), the average power consumption per hour becomes 1.75 W (=[10 W×10/60]+[0.1 W×50/60]). By contrast, if the regular standby mode is set up for over 1 hour, the average power consumption per hour becomes 10 W. Thus, when the regular standby mode is set up only in a necessary time range, the power consumption can be suppressed to a low level.

Now, the structure of the terminal device of the present invention has been described in detail; the present invention is not limited to the above-described structure and operation.

The terminal device of one aspect of the present invention includes an input section; communication means that communicates with an external device; a power supply control section that supplies power to the communication means; a calendar function section into which is set an interrupt start time and an end time and which generates an interrupt start command at the start time and an interrupt end command at the end time; a backup power supply that always supplies power to the calendar function section; and a control section that controls the power supply control section to perform a power supply operation, wherein the control section causes the power supply control section to supply power to the communication means in a time range which is decided by the interrupt start command and the interrupt end command which were generated by the calendar function section so as to allow the input section and communication section to be used. In this structure, the input section corresponds to input section 2. The communication means corresponds to communication control section 3 and interface section 4. The calendar function section corresponds to calendar IC 6.

In the above-described structure, the control section may measure, through the communication means, an elapsed time period of a state in which a signal is not supplied from the external device or an elapsed time period of a state in which an input operation is not performed on the input section, if the measured value exceeds a threshold, may set up a power saving mode in which the input section can be used and that causes a state in which a mode cancellation command is received from the input section to take place, and if the calendar function section generates the interrupt start command in the power saving mode, may cause the power supply control section to supply power to the communication means so as to allow the input section and communication means to be used.

In addition, the control section may set up interrupt start time setup information and interrupt end time setup information that have been input through the input section as the interrupt start time and interrupt end time, respectively, for the calendar function section.

In addition, the control section may receive a remote control signal from the external device through the communication means in the time range, control the power supply control section to supply power based on the remote control signal, and past the time range, maintain a power supply state based on the remote control signal.

In addition, the above-described structure may further include a light source; a spatial light modulator that modulates light supplied from the light source and generates image light; and a projection optical system that projects image light generated by the spatial light modulator, wherein the control section may cause the power supply control section to supply power to the light source based on a remote control signal received from the external device through the communication means in the time range and maintain a power supply state for the light source past the time range.

In addition, the input section may include a main body operation section including a plurality of operation buttons, the control section may cause the power supply control section to supply power to the main body operation section in a power saving mode, and the main body operation section may output to the control section a command that causes the power saving mode to be canceled when any one of the plurality of operation buttons is pressed in the power saving mode.

In addition, the input section may include a remote controller including a plurality of operation buttons, the terminal device may further include a reception circuit that receives a signal from the remote controller, the control section may cause the power supply control section to supply power to the reception circuit in a power saving mode, and the remote controller may output to the control section a command that causes the power saving mode to be canceled when any one of the plurality of operation buttons has been pressed in the power saving mode.

According to the foregoing present invention, in a time range from an interrupt start time until an interrupt end time that have been set up in advance, since power is always supplied to the communication means regardless of the operation mode, a remote control can be performed on an external device. For example, even if the power saving mode is set, the terminal device can be remotely controlled by the external device in a time range from the interrupt start time until the interrupt end time, both times which have been set up in advance. Thus, by setting up the power saving mode for the operation mode of the terminal device, power saving can be accomplished, and by remotely controlling the terminal device, that has changed to the power saving mode, by the external device through a network, convenience can be improved.

In addition, consumed power in the above-described time range, namely the regular standby mode (power consumed by the input section and the communication means) is sufficiently smaller than that in the regular mode in which power is supplied to all the functional sections. Thus, more power saving can be accomplished even in the regular standby mode than in the regular mode.

The present invention can be applied to terminal devices other than the projectors, for example, general electronic devices having a communication function.

1. A terminal device, comprising:
an input section;
communication means that communicates with an external device;
a power supply control section that supplies power to said communication means;
a calendar function section into which is set an interrupt start time and an end time and which generates an interrupt start command at the start time and an interrupt end command at the end time;
a backup power supply that always supplies power to said calendar function section; and
a control section that controls said power supply control section to perform a power supply operation,
wherein said control section causes said power supply control section to supply power to said communication means in a time range decided by the interrupt start command and the interrupt end command which were generated by said calendar function section so as to allow said input section and said communication means to be used.

2. The terminal device as set forth in claim 1,
wherein said control section measures, through said communication means, an elapsed time period of a state in which a signal is not supplied from said external device or an elapsed time period of a state in which an input operation is not performed on said input section, if the measured value exceeds a threshold, sets up a power saving mode in which said input section can be used and that causes a state in which a mode cancellation command is received from said input section to take place, and if said calendar function section generates the interrupt start command in the power saving mode, causes said power supply control section to supply power to said communication means so as to allow said input section and said communication means to be used.

3. The terminal device as set forth in claim 1,
wherein said control section sets up interrupt start time setup information and interrupt end time setup information that have been input through said input section, as said interrupt start time and interrupt end time respectively, to said calendar function section.

4. The terminal device as set forth in claim 1,
wherein said control section receives a remote control signal from said external device through said communication means in said time range, controls said power supply control section to supply power based on the remote control signal, and past said time range, maintains a power supply state based on said remote control signal.

5. The terminal device as set forth in claim 1, further comprising:
a light source;
a spatial light modulator that modulates light supplied from said light source to generate image light; and
a projection optical system that projects image light generated by said spatial light modulator,
wherein said control section causes said power supply control section to supply power to said light source based on a remote control signal received from said external device through said communication means in said time range and maintains a power supply state for said light source past said time range.

6. The terminal device as set forth in claim 1,
wherein said input section includes a main body operation section including a plurality of operation buttons,
said control section causes said power supply control section to supply power to said main body operation section in a power saving mode, and
said main body operation section outputs to said control section a command that causes said power saving mode to be canceled when any one of said plurality of operation buttons is pressed in said power saving mode.

7. The terminal device as set forth in claim 1,
wherein said input section includes a remote controller including a plurality of operation buttons,
the terminal device further comprises a reception circuit that receives a signal from said remote controller,
said control section causes said power supply control section to supply power to said reception circuit in a power saving mode, and
said remote controller outputs to said control section a command that causes said power saving mode to be canceled when any one of said plurality of operation buttons has been pressed in said power saving mode.

8. A power saving control method, comprising:
causing a backup power supply to operate a calendar function section into which is set an interrupt start time and an end time and which generates an interrupt start command at the start time and an interrupt end command at the end time; and
supplying power to communication means that communicates with an external device in a time range decided by the interrupt start command and the interrupt end command which were generated by said calendar function section.

9. The power saving control method as set forth in claim 8, further comprising:
controlling a power supply based on a remote control signal supplied from said external device through said communication means in said time range; and
past said time range, maintaining a power supply state based on said remote control signal.

10. The terminal device as set forth in claim 2,
wherein said control section sets up interrupt start time setup information and interrupt end time setup information that have been input through said input section, as said interrupt start time and interrupt end time respectively, to said calendar function section.

11. The terminal device as set forth in claim 2,
wherein said control section receives a remote control signal from said external device through said communication means in said time range, controls said power supply control section to supply power based on the remote control signal, and past said time range, maintains a power supply state based on said remote control signal.

12. The terminal device as set forth in claim 3,
wherein said control section receives a remote control signal from said external device through said communication means in said time range, controls said power supply control section to supply power based on the remote control signal, and past said time range, maintains a power supply state based on said remote control signal.

13. The terminal device as set forth in claim 2, further comprising:
a light source;
a spatial light modulator that modulates light supplied from said light source to generate image light; and
a projection optical system that projects image light generated by said spatial light modulator,
wherein said control section causes said power supply control section to supply power to said light source based on a remote control signal received from said external device through said communication means in said time range and maintains a power supply state for said light source past said time range.

14. The terminal device as set forth in claim 3, further comprising:
a light source;
a spatial light modulator that modulates light supplied from said light source to generate image light; and
a projection optical system that projects image light generated by said spatial light modulator,
wherein said control section causes said power supply control section to supply power to said light source based on a remote control signal received from said external device through said communication means in said time range and maintains a power supply state for said light source past said time range.

15. The terminal device as set forth in claim 4, further comprising:
a light source;
a spatial light modulator that modulates light supplied from said light source to generate image light; and
a projection optical system that projects image light generated by said spatial light modulator,
wherein said control section causes said power supply control section to supply power to said light source based on a remote control signal received from said external device through said communication means in said time range and maintains a power supply state for said light source past said time range.

16. The terminal device as set forth in claim 2,
wherein said input section includes a main body operation section including a plurality of operation buttons,
said control section causes said power supply control section to supply power to said main body operation section in a power saving mode, and
said main body operation section outputs to said control section a command that causes said power saving mode to be canceled when any one of said plurality of operation buttons is pressed in said power saving mode.

17. The terminal device as set forth in claim 3,
wherein said input section includes a main body operation section including a plurality of operation buttons,
said control section causes said power supply control section to supply power to said main body operation section in a power saving mode, and
said main body operation section outputs to said control section a command that causes said power saving mode to be canceled when any one of said plurality of operation buttons is pressed in said power saving mode.

18. The terminal device as set forth in claim 4,
wherein said input section includes a main body operation section including a plurality of operation buttons,
said control section causes said power supply control section to supply power to said main body operation section in a power saving mode, and
said main body operation section outputs to said control section a command that causes said power saving mode to be canceled when any one of said plurality of operation buttons is pressed in said power saving mode.

19. The terminal device as set forth in claim 5,
wherein said input section includes a main body operation section including a plurality of operation buttons,
said control section causes said power supply control section to supply power to said main body operation section in a power saving mode, and
said main body operation section outputs to said control section a command that causes said power saving mode to be canceled when any one of said plurality of operation buttons is pressed in said power saving mode.

20. The terminal device as set forth in claim 2,
wherein said input section includes a remote controller including a plurality of operation buttons,
the terminal device further comprises a reception circuit that receives a signal from said remote controller,
said control section causes said power supply control section to supply power to said reception circuit in a power saving mode, and
said remote controller outputs to said control section a command that causes said power saving mode to be canceled when any one of said plurality of operation buttons has been pressed in said power saving mode.
